(19) United States
(12) Patent Application Publication
(10) Pub. No.: US 2003/0208394 A1
(43) Pub. Date: Nov. 6, 2003

(54) Sales tracking and forecasting application tool

(76) Inventors: Todd Burris, Longview, TX (US); Christina Rouse, Cleveland Heights, OH (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/137,184

(22) Filed: May 1, 2002

(51) Int. Cl. G06F 17/60

(52) U.S. Cl. 705/10

(57) ABSTRACT

A sales tracking and forecasting system and method for integrating and manipulating data from two or more sources and then allowing a user to forecast the demand for a range of products, a specific product, a part utilized in a product, or raw materials used to manufacture a product. Possible sources of data retrieved by the system include sources internal to a seller and external to a seller.

### FIELD OF THE INVENTION

The present invention relates to the field of tracking and forecasting the production and sales of a seller of goods. More specifically, the invention relates to a system and method for sellers to dynamically predict their sales, and subsequently their material and production needs, along with comparing their actual sales to those predicted.

### BACKGROUND OF THE INVENTION

The monitoring and forecasting of production and sales of a business are standard practice, allowing a manufacturer to more accurately determine the demand for their products and to adjust their businesses accordingly. Accurate monitoring and forecasting provides more information from which intelligent business decisions can be made, and allows a business to run more efficiently.

However, current systems and methods for monitoring production and forecasting sales suffer from several disadvantages. One is that they are often very labor intensive. Data often has to be gathered from multiple departments within the company, such as the sales force, engineering community, and production line. Additionally, data is often required from outside the company, such as sales reports and forecasts from one's customers, along with market trend analysis and comprehensive sales reports from third party or commercial sources. After obtaining all the necessary information, the data has to be processed. The use of spreadsheet-type programs has simplified this step to an extent. However, this still requires that the spreadsheet be setup and the data entered into it, both of which can be lengthy and involved tasks depending on the amount of information one is attempting to process. For example, it could take two to three months, or longer, for a large corporation to produce a production and forecast report.

In a related matter, production and forecast reports are often not easily updated. Many businesses produce only one set of reports for the year and do not attempt to update them due to the significant time and effort it would require. These “static” reports are subsequently not as accurate as they could be as they do not take into account relevant changes that occur after their production.

Current systems also typically do not provide a thorough detailed analysis. Due to the time and effort involved in gathering the data and generating the reports, the level of detail available from the analysis is often limited. For example, current systems often will provide information only down to a level relating to the production and sales of a final product. Further information, such as that relating to the components and raw materials required to produce the product, are typically not taken into account.

An additional problem concerning typical systems and methods for tracking and forecasting the production and sales of a business is that they often cannot be easily reconfigured once they have been setup. It is desirable to be able to adapt the reports generated by the system so as to be specific to the person or department utilizing the information. For example, the accounting department may only be seeking information relevant to the costs incurred for a specific project, while a production line manager desires information concerning customer demand for the upcoming month for a specific part. However, due to the difficulty in reconfiguring a report for specific data, such customization is often not available.

Accordingly, the inventors hereof have recognized the need for a new system and method for tracking and forecasting the production and sales of a seller of goods.

### SUMMARY OF THE INVENTION

The invention is directed to a new system and method for tracking and forecasting product sales. The new system includes at least two different input sources of data and a central processor that can selectively retrieve data from the sources, integrate the data at different levels, and manipulate it and report it at different levels of detail as selected by a user.

### BRIEF DESCRIPTION OF THE DRAWINGS

In the drawings:

FIG. 1 is a simplified depiction of a sales tracking and forecasting system embodying the present invention, according to a preferred embodiment.

FIG. 2 lists examples of possible sources of data, in a hierarchical structure, that can be utilized by the present system.

FIG. 3 lists examples of the type of reports that can be generated by the present system.

FIG. 4 depicts a representative example of a product line and its various levels of detail that can be examined within a report.

FIG. 5 lists examples of other types of systems into which data generated by the tracking and forecasting system can be integrated.

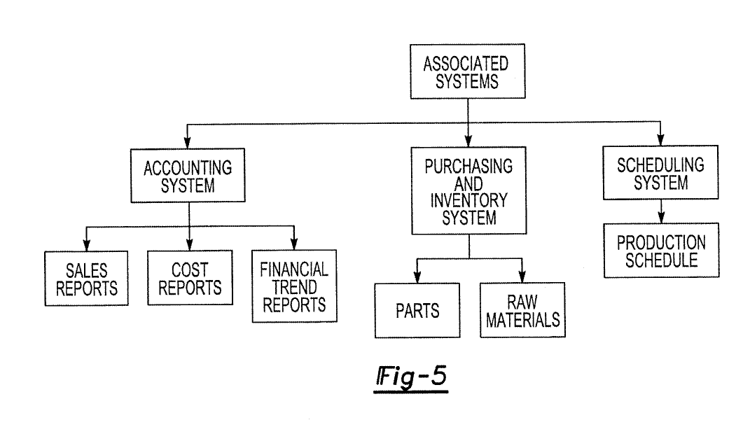

### DESCRIPTION OF THE PREFERRED EMBODIMENT

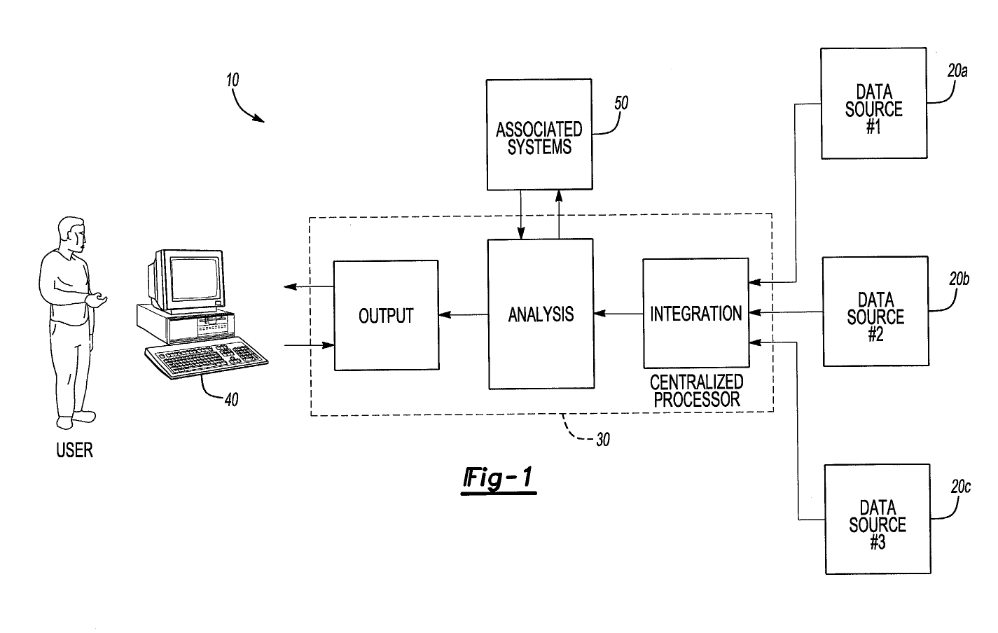

FIG. 1 illustrates one embodiment of the monitoring and forecasting system 10 in accordance with the present invention. A centralized computer server or processor 30 is host to various applications that make up a majority of the system. Some of these applications are means for retrieving information from various sources of data 20A, 20B and 20C. These sources range from internal sources, such as other computer systems within the same company or corporation, to external sources such as customer and third party systems. Data can be retrieved in numerous ways, such as, for example, through a local area network (LAN), the World Wide Web, or other electronic data interchange (EDI) means.

A user accesses and interacts with the centralized server, thereby retrieving tracking and forecasting data and generating reports. According to a first embodiment, access could be by means of a typical Internet browsing program running on a standard personal computer (PC) 40 connected to a LAN. In an alternate embodiment, the system can be configured so that access can be achieved through a computer connected to the World Wide Web. Further embodiments could provide access through virtually any computing device with means of communicating with the World Wide Web, for example, a personal digital assistant (PDA) with wireless communication capabilities.

The tracking and forecasting system of the present invention can also be configured so that various associated systems 50 can communicate with it. One possible embodiment would allow systems of other departments within the same company, such as accounting and scheduling systems, to request and retrieve data from the centralized server. An additional embodiment would allow a system external to the company, such as an ordering system of a supplier, to also communicate with the company's tracking and forecasting system.

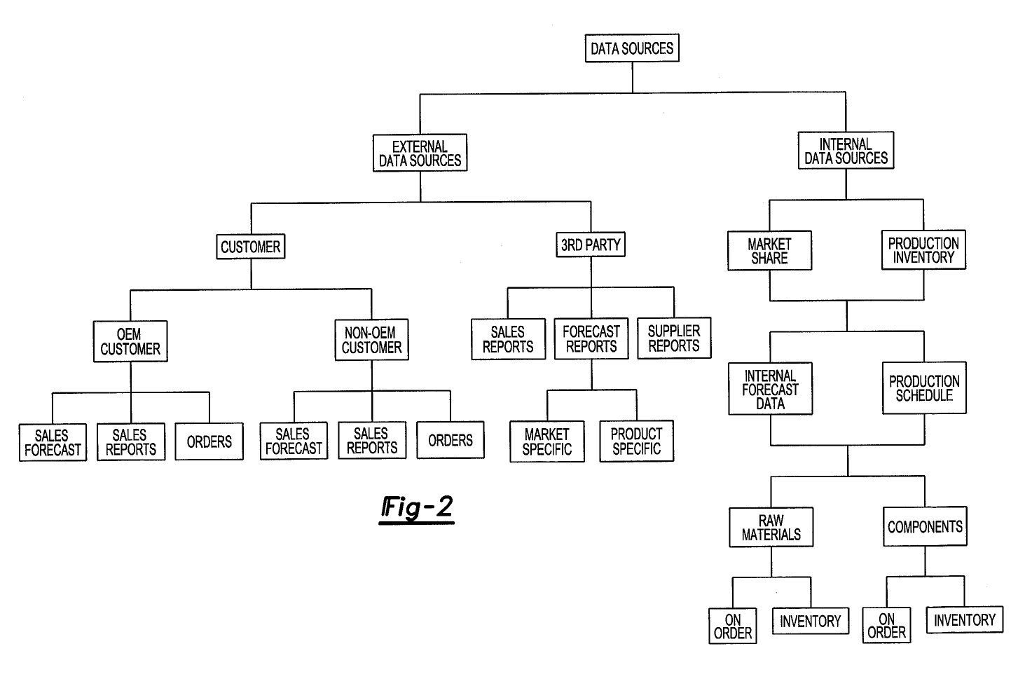

Now the operation and capabilities of the system according to the present embodiment will be described in detail. To provide accurate forecasts for product demands of a manufacturer, seller, assembler or distributor (hereafter “manufacturer”), information can be retrieved from numerous sources of data that can be either internal or external to the company. As illustrated in FIG. 2, one example of a possible external source of information is a third party commercial service that provides industry-related data and forecasts. In example, Price, Waterhouse and Coopers provides online access to a variety of sales and forecast data relating to the automotive industry. Available information includes, among other things, sales reports by vehicle model or type, vehicle build projections by model and type, and orders and projected sales for a specific model or type of vehicle.

Another important external source of information is the manufacturer's customers, which can range from component retailers to original equipment manufacturers (OEMs) who distributes end products that contains other companies components. Information, ranging from order projections to sales reports and forecasts, can be retrieved from a centralized source provided by the customer such as their mainframe computer. Alternatively, customer data could be obtained from non-centralized locations such as one or more customer plants.

Other examples of external sources of information include suppliers of parts and materials utilized by the manufacturer, or even other manufacturers who provide related products and services.

Information that could be retrieved from sources within the company ranges from current market share, such as for a specific product or group of products, to the present production inventory. Below this general level, more detailed information relating to aspects such as internally generated forecast reports and production schedules could also be retrieved. Residing below that level of information is further retrievable data concerning current inventory and order status of components and raw materials utilized in the manufacturing process. This data can be subsequently grouped according to predicted materials needed to fulfill the forecasted demand for either a specific component, product or range of products. Beyond the above examples, which are provided for illustrative purposes, virtually any other type of external or internal source of data could be utilized if it provides access to relevant or useful information.

After retrieval of all the desired information from the various external and internal sources, the data relating to the different levels of production and sales must then be integrated and analyzed. By integration of these different levels of data, a complete analysis concerning all aspects of the business can be accomplished. Examples of different levels of data that is eventually integrated include information relating to OEM product sales and projections, information concerning the inventory and sales of an individual product or component, and the current inventory and order status of raw materials used in the manufacturing process.

Integration of the above data can be accomplished by various means. One such means could simply entail the combining of two data sets. A second means of integration could be accomplished by simply subtracting one data set from another. Alternatively, if subsets of data need to be manipulated, a pro rate adjustment can be performed. Beyond the above examples provided for illustrative purposes, other heuristics methods could be developed and utilized.

Once all the information is integrated and analyzed, a user can then access the centralized server and generate a report tailored to his or her needs. Unlike some systems which require specialized hardware, the tracking and forecasting system of the present invention allows access and interaction with the system through means such as a standard web browsing program, such as Microsoft Internet Explorer or other equivalent software. By relying on such a common interface, devices ranging from dedicated workstations, the more typical PC, or even a PDA can be used to access and retrieve tracking and forecasting data. Accordingly, minimum expense is associated with the system, as it often can be implemented using equipment already in a company's possession.

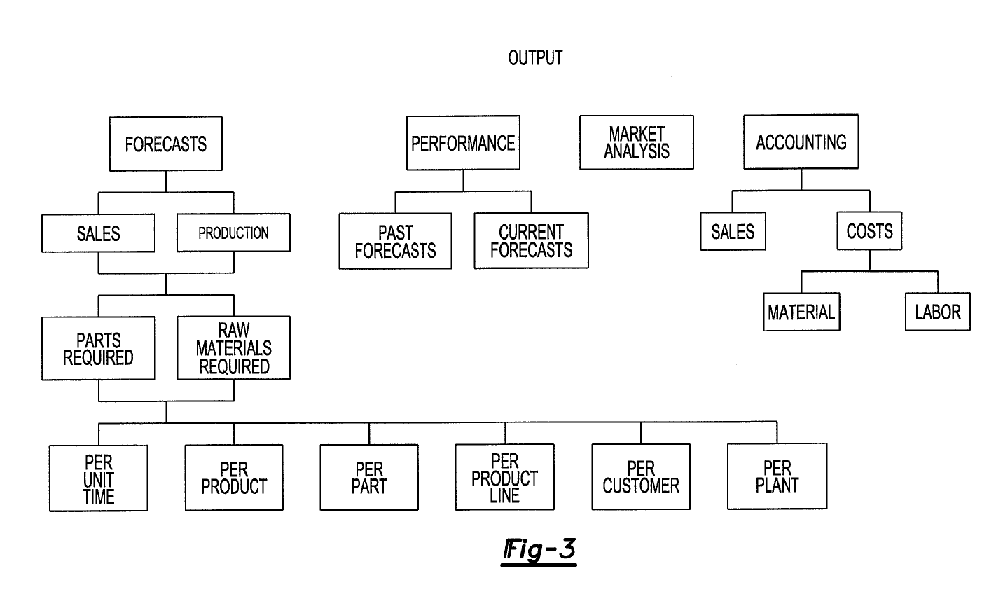

Due to the flexibility of the system, and the large amount of information entered into it relating to virtually all business aspects of the manufacturer, a wide range of reports is readily available to a user. FIG. 3 lists, in a hierarchical structure, examples of some of the types of reports that can be generated. Forecasting reports can be tailored to predict future sales, production requirements and necessary inventory. Further, the scope of these predictions can be adjusted to varying levels of detail. This allows for predictions relating to a class or range of products, or if greater detail is desired, only to one specific product, component or raw material. Additionally, this prediction data can be further broken down based on qualifiers. Several examples include qualifiers relating to a unit of time, or a specific customer, part, product line or manufacturing plant. Consequently, very specific and detailed forecasts can be now generated, such as an expected amount of raw material required per customer per plant per month.

Additional report examples include accounting reports, which could be concerned with issues such as fiscal sales or material and labor costs. Other examples include performance reports and market analysis reports, which will discussed below.

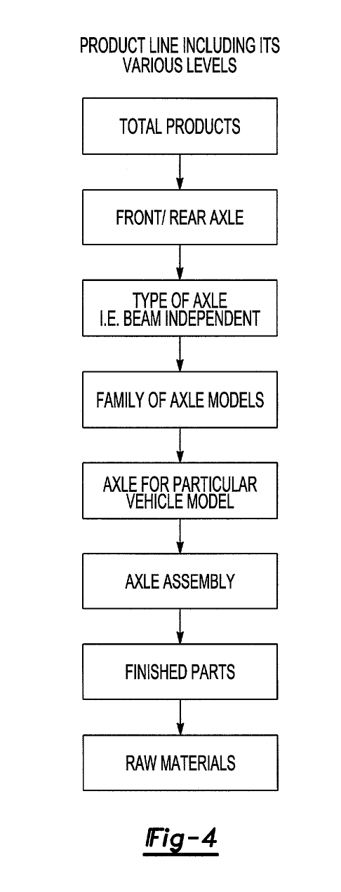

Another advantage of the present invention is how it integrates data from different levels and then provides the ability for a user to manipulate a report “on the fly” so as to provide greater detail. This ability to “drill” down from one level of detail to the next can lead to the observation of characteristics, such as performances, trends and discrepancies within the data, which otherwise might go unnoticed. For example, an executive may notice nothing unusual upon looking at tracking and forecasting data concerning their total product line. However, upon “drilling” down through a specific product line, such as that illustrated in FIG. 4 for an automobile axle, he or she may notice discrepancies concerning the number of manufactured axles or their production schedule.

The flexibility of the current system also allows existing reports to be easily modified or new types of reports created based on the needs of a specific user. For example, someone in the sales department may wish to examine data only pertaining to the sales of a particular product. Further, he or she may desire a breakdown of those sales based on customer size and location. Another user responsible for the production schedule of a product line may wish to view data only pertaining to expected sales of that product line for the upcoming year. Due to the ease in which a report can be modified or created, each user can quickly obtain a report addressing their specific needs.

This flexibility in controlling what data goes into a report also provides for greater security. For example, users dealing with production line operation typically do not need access to specific revenue information, while a senior executive of the company typically does. Accordingly, the system can be programmed to leave out revenue information from any reports generated by production line personnel, but provide detailed revenue information for reports generated by executives.

In an additional embodiment, the tracking and forecasting system of the present invention can be further configured to provide various degrees of performance analysis. This is accomplished by comparing previous forecast data to actual production and sales data, thereby allowing the accuracy of the forecast data to be evaluated. Additionally, this provides the ability to modify current and future forecast data based on prior correctable discrepancies, thereby increasing the accuracy of the forecasts.

Another embodiment of the present invention incorporates means for performing global market analysis into the tracking and forecasting system. No current system provides for an easy automated method for tracking the activity of competitors. For example, other manufacturers of automotive components. However, many third party commercial services, such as those already relied upon as a source of data, are capable of tracking and providing information concerning a wide range of activities within a specific field or industry. As one example relating to the automotive industry, information concerning automobile-related manufacturing from across the world could be retrieved and analyzed, thereby revealing the sales and activities of a competitor. Such market analysis allows for educated decisions to be made regarding issues such as whether to establish business in a foreign country. For example, beyond the basic question of what the activity level is in the specified country, further questions that could likely be answered include the likely percentage of market share that could be obtained, and whether it would be profitable to do business in that region.

Beyond providing data to users, the system according to a further embodiment allows for tracking and forecasting data to be pulled from the centralized server to other associated systems. These associated systems include, but are not limited to, accounting systems, purchasing and inventory systems and scheduling systems. By directly retrieving forecasting data, these associated systems can function more independently and efficiently. For example, by incorporating forecast data with its own, the accounting system can automatically generate costs and sales reports, along with financial trend reports. Similarly, a purchasing and inventory system could provide an indication that more supplies need to be ordered based not only on current inventory, but also predicted demand and usage of those supplies. Lastly, a scheduling system could automatically adjust a production schedule, or alternatively provide an indication to a user that an adjustment is needed in a production schedule, so as to meet expected demands based on forecasted sales.

While the invention has been specifically described in connection with certain embodiments thereof, it is to be understood that this is by way of illustration and not of limitation, and the scope of the appended claims should be construed as broadly as the prior art will permit.

What is claimed:

1. A system for tracking and forecasting product sales, comprising:
at least two different input sources of data; and
a central processor that selectively retrieves data from the at least two different input sources.

2. The system according to claim 1, wherein the central processor includes:
an integration subsystem for integrating at different levels data acquired from the at least two data sources;
an analysis subsystem for manipulating the integrated data at different levels of detail; and
an output subsystem for reporting the manipulated data at different levels of detail as selected by a user.

3. The system according to claim 2, further comprising means for integrating the manipulated data with an ordering system.

4. The system according to claim 3, wherein the ordering system places orders for raw materials used in a manufacturing process.

5. The system according to claim 3, wherein the ordering system places orders for parts used in a manufacturing process.

6. The system according to claim 3, wherein the means for integrating the manipulated data with the ordering system is automatic.

7. The system according to claim 2, further comprising means for integrating the manipulated data with an accounting system.

8. The system according to claim 2, further comprising means for integrating the manipulated data with a scheduling system.

9. The system according to claim 2, wherein at least one input source of data is external to a manufacturing process.

10. The system according to claim 9, wherein at least one of the external input sources of data is a customer.

11. The system according to claim 9, wherein at least one of the external input sources of data is a third party.

12. The system according to claim 2, wherein at least one input source of data is internal to a manufacturing process.

13. A method for forecasting the demand for a product, comprising the steps:
acquiring data from two or more different sources;
performing different levels of analysis on the acquired data; and
producing forecast reports with varying levels of detail as selected by a user.

14. The method according to claim 13, wherein at least a portion of the data is acquired from sources external to a manufacturing process.

15. The method according to claim 14, wherein one source of data is the World Wide Web.

16. The method according to claim 14, wherein one source of data is sales reports from official equipment manufacturers (OEMs).

17. The method according to claim 14, wherein one source of data is customer reports.

18. The method according to claim 13, wherein at least a portion of the data is acquired from sources directly related to the manufacturing process.

19. The method according to claim 18, wherein one source of data is internal management forecast reports.

20. The method according to claim 18, wherein one source of data is a production schedule of a particular part.

21. The method according to claim 18, wherein one source of data is a current inventory listing.

22. The method according to claim 13, further comprising predicting a demand for raw materials based on the acquired data.
